(19) United States
(12) Patent Application Publication
(10) Pub. No.: US 2007/0075280 A1
(43) Pub. Date: Apr. 5, 2007

(54) Optical ranging sensor and electrical equipment

(75) Inventors: Takahiko Nakano, Katsuragi-shi (JP); Akifumi Yamaguchi, Kashiba-shi (JP)

Correspondence Address: NIXON & VANDERHYE, PC, 901 NORTH GLEBE ROAD, 11TH FLOOR, ARLINGTON, VA, 22203, US

(73) Assignee: SHARP KABUSHIKI KAISHA, Osaka (JP)

(21) Appl. No.: 11/529,277

(22) Filed: Sep. 29, 2006

(30) Foreign Application Priority Data
Sep. 30, 2005 (JP) 2005-288440

(51) Int. Cl. G01C 3/08

(52) U.S. Cl. 250/559.38; 356/3.01

(57) ABSTRACT

An optical ranging sensor 1 includes a light emitting diode 2, a light projecting lens 3 for condensing light from the light emitting diode 2 and projecting the light onto an object to be ranged, a light receiving lens 4 for condensing reflected light from the object to be ranged, and a light receiving device 5 for receiving the light condensed by the light receiving lens 4. A signal processing circuit 7 having received two signal currents I1, I2 from the light receiving device 5 outputs output signal S indicating a distance D to the object to be ranged and close-distance signal N indicating whether the object to be ranged is in a close distance zone. According to the optical ranging sensor 1, the disadvantage that the object being in the close distance zone misdetected as is in the normal ranging zone can be prevented.

### CROSS-REFERENCE TO RELATED APPLICATIONS

This nonprovisional application claims priority under 35 U.S.C. §119(a) on Patent Application No(s). 2005-288440 filed in Japan on Sep. 30, 2005, the entire contents of which are hereby incorporated by reference.

### BACKGROUND OF THE INVENTION

The present invention relates to an optical ranging sensor of trigonometrical ranging type for measuring a distance to an object to be ranged by projecting light onto the object and receiving reflected light.

As shown in FIG. 8, among conventional optical ranging sensors is a ranging sensor that detects in a trigonometrical ranging method a distance to an object to be ranged by projecting light and receiving the reflected light (JP 2003-156328 A). The ranging sensor 100 is generally composed of a light emitting diode 102 for projecting light onto the object to be ranged (not shown), a light projecting lens 103 for condensing the light to be projected, a light receiving lens 104 for condensing the light reflected by the object to be ranged, and a light receiving device 105 for receiving the light condensed by the light receiving lens 104.

The light receiving device 105 is composed of a PSD (Position Sensitive Device). The reflected light diffused and reflected by the object to be ranged is focused by the light receiving lens 104 provided in front of a light receiving surface 105a of the light receiving device 105 and is guided onto the light receiving surface 105a.

In the ranging sensor 100 having the above configuration, part of the light diffused and reflected by the object to be ranged is focused by the light receiving lens 104 and is made incident on the light receiving surface 105a so as to form a light spot thereon. An incidence position of the incident light on the light receiving surface 105a changes with a distance between the object to be ranged and the ranging sensor 100. When the position of the light spot on the light receiving surface 105a shifts from a reference position, signal currents I1, I2 taken from both ends of the light receiving device 105 change according to a quantity of the shift. The signal currents I1, I2 from the light receiving device 105 are converted, by a signal processing circuit in a control unit (not shown), into output signals S1, S2 expressed by the following equations (1) and (2).
S1=I1/(I1+I2) (1)
S2=(I1−I2)/(I1+I2) (2)
The signal currents I1, I2 are expressed by the following equations (3) and (4):
I1={(d+2x)·I0}/(2d) (3)
I2={(d−2x)·I0}/(2d) (4)

wherein d is a range in which the light spot travels on the light receiving surface 105a,

I0 is a total photo current (I1+I2), and

x is a distance from a center of the light receiving device (PSD) 105 to the position of the light spot.

Based on a principle of the trigonometrical ranging, a relation of the following equation (5) holds:
X=(A·f)/L (5)

wherein X is a distance from an optical axis of the light receiving lens 104 to the position of the light spot on the light receiving device (PSD) 105,

A is a distance (base length) between an optical axis of the light projecting lens 103 and the optical axis of the light receiving lens 104,

f is a focal length of the light receiving lens 104, and

L is a range in which ranging can be carried out.

With substitution of the equation (5) into the equations (1) through (4), the output signals S1, S2 can be expressed as follows:

$$\begin{matrix}S 1 = ( 2 x + d ) / ( 2 d ) \\ = [ \{ ( A \cdot f / L ) - B \} / d ] + 1 / 2 & ( 6 ) \\ S 2 = 2 x / d \\ = 2 \{ ( A \cdot f / L ) - B \} / d & ( 7 )\end{matrix}$$

wherein B is a distance from an optical axis of the light receiving lens 104 for receiving light to the center of the light receiving device (PSD) 105. There exists a relation X=B+x.

FIG. 9 is a diagram showing change in the output signal S from the ranging sensor 100 that corresponds to the change in distance to the object to be ranged. As apparent from FIG. 9, the change in the output signal S from the ranging sensor 100 is inversely proportional to the distance D to the object to be ranged, basically based on the equations (6), (7) representing the output signals S1, S2. That is, as the distance D from the optical ranging sensor to the object to be ranged increases, the position of the light spot on the light receiving surface 105a of the light receiving device 105 shifts to left in FIG. 8, and a quantity of the shift of the light spot decreases. Concomitantly, a quantity of the change (quantity of the decrease) in the output signal S in FIG. 9 decreases. As the distance D from the optical ranging sensor to the object to be ranged decreases, on the other hand, the position of the light spot on the light receiving surface 105a of the light receiving device 105 shifts to right in FIG. 8, and the quantity of the shift (quantity of the increase) of the light spot increases. When the distance D to the object to be ranged is made smaller than a predetermined close distance and the object to be ranged comes into a close distance zone, the position of the light spot shifts beyond an edge of the light receiving surface 105a of the light receiving device 105 to outside of the light receiving surface 105a, so that a quantity of light that the light receiving device 105 receives rapidly decreases. Concomitantly, the output signal S in FIG. 9 is rapidly weakened. Therefore, the optical ranging sensor generally defines such a region as a ranging zone L that a reflected light from the region makes light spot within the light receiving surface 105a, i.e., the light receiving device outputs a signal S inversely proportional to the distance D to the object.

The conventional ranging sensor 100, however, has such a problem as follows. When the distance to the object is determined with a threshold T of the output signal S, as shown in FIG. 9, the same threshold T of the output signal S may appear in both cases in which the object is in the close distance zone and in the ranging zone L. When the distance to the object is detected based only on the output signal S, therefore, there is a disadvantage that the object is misdetected being in the normal ranging zone despite being in the close distance zone.

### SUMMARY OF THE INVENTION

An object of the present invention is to provide an optical ranging sensor that is capable of preventing a disadvantage in which an object to be ranged is misdetected being in a normal ranging zone despite being in a close distance zone.

In order to achieve the above object, there is provided an optical ranging sensor of trigonometrical ranging type, comprising:

a light emitting device for emitting light;

a light projecting condenser unit for condensing the light emitted from the light emitting device and projecting the light onto an object to be ranged;

a light receiving condenser unit for condensing the light projected onto and reflected by the object to be ranged;

a first light receiving device for receiving the light condensed by the light receiving condenser unit and outputting distance signal corresponding to a distance to the object to be ranged; and

a close-distance detection circuit for detecting whether the object to be ranged is in a predetermined close distance zone.

According to the optical ranging sensor having the above configuration, the light emitted from the light emitting device is projected through the light projecting condenser unit onto the object to be ranged, and is diffused and reflected by the object. Part of the reflected light is condensed by the light receiving condenser unit and is made incident on the first light receiving device. The distance signal corresponding to the distance to the object is outputted from the first light receiving device having received the light. The close-distance detection circuit detects whether the object is in the predetermined close distance zone. Thus a disadvantage that the object existing in the close distance zone is misdetected as is in a normal ranging zone can be prevented based on the distance signal.

The first light receiving device preferably has a light receiving surface for receiving the light and at least two electrodes for outputting signals from which a light receiving position on the light receiving surface is calculated. The term “close distance” refers to such a decreased distance to the object that the light reflected by the object is not incident on and out of the light receiving surface of the optical ranging sensor.

In one embodiment of the invention, the optical ranging sensor further comprises a close-distance signal output unit for outputting a close-distance signal indicating presence or absence of the object to be ranged in the close-distance zone, based on a result of detection by the close-distance detection circuit.

According to the above embodiment, the distance to the object to be ranged can accurately be detected based on the close-distance signal outputted from the close-distance signal output unit and the distance signal outputted from the first light receiving device.

In one embodiment of the invention, the optical ranging sensor further comprises an output control unit that outputs to external the distance signal from the first light receiving device when the close-distance detection circuit detects absence of the object to be ranged in the close distance zone and that outputs to external the close-distance signal from the close-distance signal output unit when the close-distance detection circuit detects presence of the object to be ranged in the close distance zone.

According to the above embodiment, the optical ranging sensor outputs from the output control unit the distance signal when the object is not in the close distance zone and the close-distance signal when the object is in the close distance zone. Thus a disadvantage that a signal indicating a distance outside the close distance zone is outputted though the object is actually in the close distance zone can effectively be prevented.

In one embodiment of the invention, the second light receiving device receives light emitted from the light emitting device and reflected by the object to be ranged existing in the close distance zone.

According to the above embodiment, the second light receiving device receives the light emitted from the light emitting device and reflected by the object existing in the close distance zone. Based on a signal from the second light receiving device, presence of the object in the close distance zone can reliably be detected.

In one embodiment of the invention, the first light receiving device and the second light receiving device are formed on one board.

According to the above embodiment, by forming both the devices on one board, mutual position of the first light receiving device and the second light receiving device can be determined with high accuracy. Accordingly, whether the object is in the close distance zone can be detected with high accuracy. Besides, the optical ranging sensor can be miniaturized.

In one embodiment of the invention, the first light receiving device and the close-distance detection circuit are formed on one board.

According to the above embodiment, influence of noises can be reduced and ranging accuracy, detection accuracy for the close distance, and the like can be improved by forming the first light receiving device having a comparatively small output power and the close-distance detection circuit on one common board. In addition, the optical ranging sensor can be miniaturized.

In one embodiment of the invention, the optical ranging sensor further comprises a determination output circuit that determines and outputs whether the distance to the object to be ranged is larger than a predetermined reference distance, based on the distance signal outputted from the first light receiving device and a reference signal inputted from external and indicating the predetermined reference distance.

According to the above embodiment, a position of the object can be outputted with use of two-value information by the determination output circuit that determines and outputs whether the distance to the object is larger than the reference distance.

In one embodiment of the invention, the optical ranging sensor further comprises a distance zone detection output circuit that identifies and outputs which zone the object to be ranged exists in out of a plurality of distance zones defined by predetermined reference distances, based on the distance signal outputted from the first light receiving device and a plurality of reference signals inputted from external and indicating the predetermined reference distances.

According to the above embodiment, a position of the object can be outputted with use of information of three or more values by the distance zone detection output circuit that identifies and outputs a zone in which the object exists out of the plurality of distance zones.

There is also provided an electrical equipment comprising the above optical ranging sensor.

The optical ranging sensor accurately detects the presence of the object in the close distance zone, and therefore the above electrical equipment is capable of accurately operating based on a result of the detection. Among the electrical equipment are automatic faucet device, automatic drier device, automatic washing toilet seat device, automatic switching valve seat device, automatic vacuum cleaner, and the like, for example.

The optical ranging sensors of the invention, as described above, the close-distance detection circuit detects whether the object is in the predetermined close distance zone. Thus a disadvantage that the object existing in the close distance zone is misdetected as is in the normal ranging zone can be prevented based on the distance signal from the first light receiving device.

### BRIEF DESCRIPTION OF THE DRAWINGS

The present invention will become more fully understood from the detailed description given hereinbelow and the accompanying drawings which are given by way of illustration only, and thus are not intended to limit the present invention, and wherein:

FIG. 1 is a schematic diagram showing a configuration of an optical ranging sensor according to a first embodiment;

FIG. 2 is a diagram showing a light receiving lens and a light receiving device of the optical ranging sensor;

FIG. 3 is a graph showing change in output signal corresponding to change in a distance to an object to be ranged;

FIG. 4 is a graph showing another example of signal that a signal processing circuit outputs;

FIG. 5 is a schematic diagram showing light receiving devices that an optical ranging sensor according to a second embodiment has;

FIG. 6 is a graph showing signals outputted from a signal processing circuit of an optical ranging sensor according to a third embodiment;

FIG. 7 is a graph showing signals outputted from a signal processing circuit of an optical ranging sensor according to a fourth embodiment;

FIG. 8 is a schematic diagram showing a conventional optical ranging sensor; and

FIG. 9 is a graph showing output signal from the conventional optical ranging sensor.

### DETAILED DESCRIPTION OF THE INVENTION

Hereinbelow, the invention will be described in detail with reference to embodiments shown in the drawings.

### First Embodiment

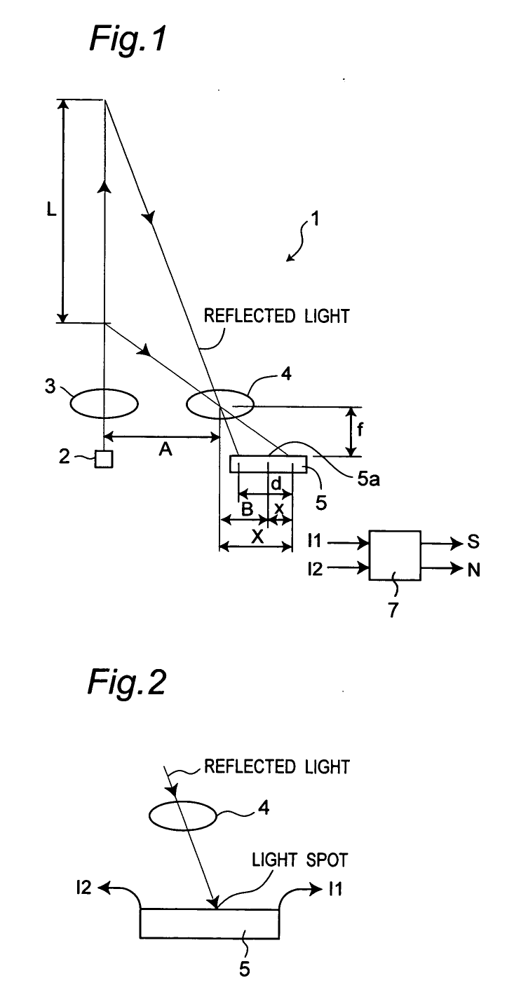

FIG. 1 is a schematic diagram showing a configuration of an optical ranging sensor according to an embodiment of the invention.

The ranging sensor 1 includes a light emitting diode 2 as a light emitting device for emitting light, a light projecting lens 3 as a light projecting condenser unit for condensing the light emitted from the light emitting diode 2 and projecting the light onto an object to be ranged (not shown), a light receiving lens 4 as a light receiving condenser unit for condensing the light reflected by the object to be ranged, a light receiving device 5 as a first light receiving device for receiving the light condensed by the light receiving lens 4, and a signal processing circuit 7 into which signals are inputted from the light receiving device 5.

The light receiving device 5 is composed of a PSD. The reflected light diffused and reflected by the object to be ranged is focused by the light receiving lens 4 provided in front of a light receiving surface 5a and is made incident on the light receiving surface 5a so as to form a spot thereon.

FIG. 2 is a diagram showing the light receiving lens 4 and the light receiving device 5 of the optical ranging sensor 1. The light receiving device 5 is formed of a pin photodiode, and has the light receiving surface that extends generally in parallel with a line linking the light projecting lens 3 and the light receiving lens 4 and that is shaped like a slender rectangle. At both ends of the light receiving surface shaped like the slender rectangle are formed a first electrode and a second electrode. From the first electrode and the second electrode are outputted signal currents I1, I2 corresponding to a position irradiated with the light spot on the light receiving surface.

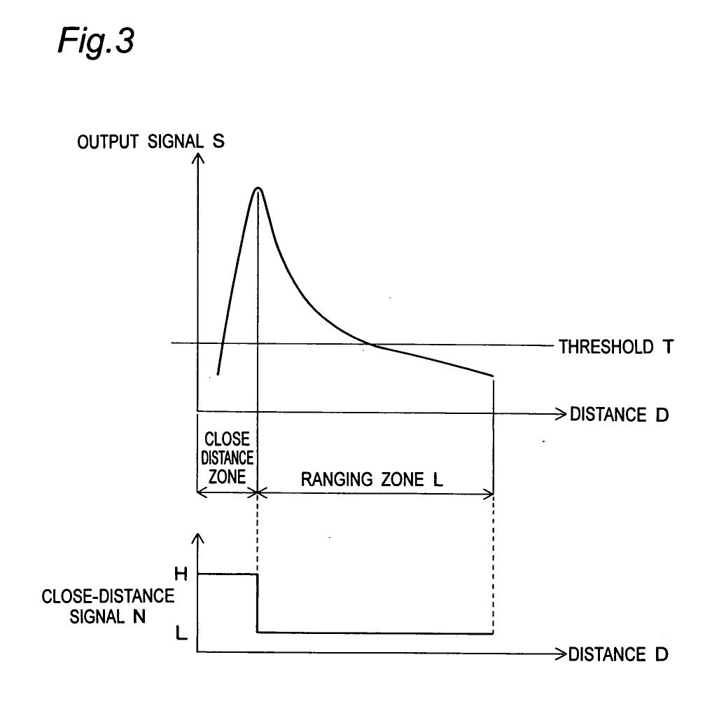

The signal processing circuit 7 outputs output S signal indicating a distance to the object to be ranged, by means of a trigonometrical ranging method with use of the signal currents I1, I2 outputted from the light receiving device 5 and the equations (1) through (7) of the prior art. FIG. 3 is a graph showing change in the output signal S that the signal processing circuit 7 outputs corresponding to change in a distance D from the optical ranging sensor to the object to be ranged. In FIG. 3, an axis of ordinate represents magnitude of the signal S, and an axis of abscissa represents the distance D to the object to be ranged. Based on such a relation as shown in the graph of FIG. 3, comparison is carried out between the output signal S and the threshold T as reference signal inputted from external, and whether the distance to the object to be ranged is larger than a distance corresponding to the threshold T is determined. Alternatively, the distance to the object to be ranged is determined from a value of the output signal S.

In addition, the signal processing circuit 7 of the embodiment determines whether the object to be ranged is in a predetermined close distance zone, based on the signal currents I1, I2 from the light receiving device 5, and outputs a close distance signal N indicating a result of the determination. Whether the object to be ranged is in the predetermined close distance zone is determined as follows.

When the object to be ranged is in the ranging zone L, a relation between the signal currents I1 and I2 from the light receiving device 5 is expressed by the following equation (8):
I1=α−I2 (8)

wherein α is a coefficient corresponding to the position of the light spot on the light receiving surface.

When the object to be ranged is in the close distance zone that is nearer to the light projecting lens 3 than the ranging zone L, the light spot on the light receiving device shifts beyond an edge of the light receiving surface and is positioned in vicinity of a right end of the light receiving device 5 in FIG. 2. Accordingly, a value of the signal current I2 is almost nullified, so that a relation I1>>I2 holds. Then the signal processing circuit 7 calculates a ratio R expressed by the following equation (9), with use of the signal currents I1, I2 from the light receiving device 5.
R=I2/I1 (9)
When the ratio R is smaller than a predetermined reference value, it is determined that the object to be ranged is in the close distance zone. The reference value is obtained from the currents I2, I1 corresponding to a peak of the output signal S in FIG. 3.

Upon determining from the equation (9) that the object to be ranged is in the close distance zone, the signal processing circuit 7 outputs a close-distance signal N of H (High) as shown in FIG. 3. Upon determining that the object to be ranged is not in the close distance zone, on the other hand, the circuit 7 outputs a close-distance signal N of L (Low). Thus the signal processing circuit 7 functions as a close-distance detection circuit and a close-distance-signal output unit of the invention.

According to the optical ranging sensor of the embodiment, the signal processing circuit 7 outputs the output signal S indicating the distance to the object to be ranged and outputs the close-distance signal N indicating whether the object to be ranged is in the close distance zone. Even if the distances D corresponding to the predetermined threshold T of the output signal S exist in both the close distance zone and the ranging zone L as shown in FIG. 3, therefore, the accurate distance D to the object to be ranged can be detected with reference to the close-distance signal N. That is, it is detected that the object exists at the distance D in the ranging zone L corresponding to the output signal S when the close-distance signal N is L. When the close-distance signal N is H, it is detected that the object exists in the close distance zone.

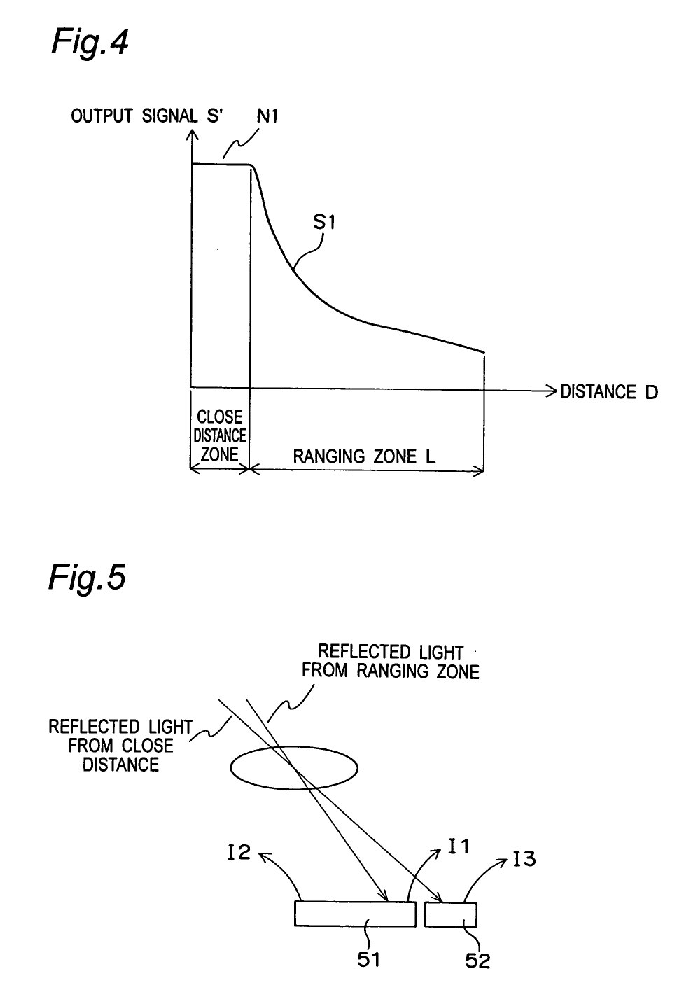

In the embodiment, the signal processing circuit 7 outputs the close-distance signal N independently of the output signal S. However, the signal processing circuit 7 may output a combined signal of the output signal S and the close-distance signal N. That is, when it is detected that the object does not exist in the close distance zone (i.e., the object exists in the ranging zone L) as the ratio R calculated from the equation (9) is larger than the reference value, then a signal S1 based on the signal currents I1, I2 from the light receiving device 5 is outputted as shown in FIG. 4. While it is determined that the object exists in the close distance zone, then a signal N1 indicating that the object is in the close distance zone is outputted. By causing a value of the signal N1 to be larger than a maximum value of the signal S1, a distinction can be made between the signal N1 and the signal S1, and both the distance to the object and the presence or absence of the object in the close distance zone can be outputted with use of a single output signal S′.

The light receiving device 5 and the signal processing circuit 7 can be formed as one chip on the same board. The signal currents outputted from the light receiving device 5 are fine currents on the order of nA (nanoampere) or smaller. Therefore the formation of the light receiving device 5 and the signal processing circuit 7 on the same board reduces influence of noise. As a result, the calculation of the output signal S indicating the distance to the object to be ranged and the determination of the presence or absence of the object to be ranged in the close distance zone can be performed more accurately.

### Second Embodiment

FIG. 5 is a schematic diagram showing light receiving devices with which an optical ranging sensor according to a second embodiment is provided. The optical ranging sensor according to the embodiment has a first light receiving device 51 similar to the light receiving device 5 of the first embodiment and a second light receiving device 52 adjacent to the first light receiving device 51. The second light receiving device 52 outputs a single output current I3 indicating whether light is received by the device 52. The second light receiving device 52 has a light receiving surface included in a plane generally the same as a light receiving surface of the first light receiving device 51. The second light receiving device 52 is placed on a side farther from a light emitting diode 2 with respect to the first light receiving device 51. The optical ranging sensor of the second embodiment has the same configuration as the optical ranging sensor of the first embodiment except the second light receiving device 52. For the second embodiment, detailed description of the same parts thereof as those of the first embodiment is omitted with using the same reference numerals as the first embodiment.

In the optical ranging sensor of the second embodiment, reflected light from the object that exists in the ranging zone L is incident on the first light receiving device 51. On the other hand, reflected light from the object that exists in the close distance zone is incident on the second light receiving device 52. Thus a distance to the object can be detected based on the signal currents I1, I2 from the first light receiving device 51 when the object is in the ranging zone L. While the object is in the close distance zone, the presence of the object in the close distance zone can be detected based on the signal from the second light receiving device 52. The determination of the presence of the object in the close distance zone is performed, for example, such that it is determined that the object is in the close distance zone, when the signal current I3 from the second light receiving device 52 is larger than a predetermined threshold Ia.

In the optical ranging sensor according to the embodiment, the first light receiving device 51 and the second light receiving device 52 may be formed as one chip on the same board. By forming the first light receiving device 51 and the second light receiving device 52 as one chip, it becomes possible to accurately set positions of the devices relative to each other. As a result, the presence or absence of the object in the close distance zone can be determined accurately.

Furthermore, the first light receiving device 51, the second light receiving device 52, and the signal processing circuit 7 may be formed as one chip on the same board. Thus the calculation of the output signal S indicating the distance to the object and the determination of the presence or absence of the object in the close distance zone can be performed more accurately.

### Third Embodiment

An optical ranging sensor of a third embodiment has substantially the same configuration as the optical ranging sensor 1 of the first embodiment except signals outputted from the signal processing circuit 7. For the present embodiment, detailed description of the same parts thereof as those of the first embodiment is omitted with using the same reference numerals as the first embodiment.

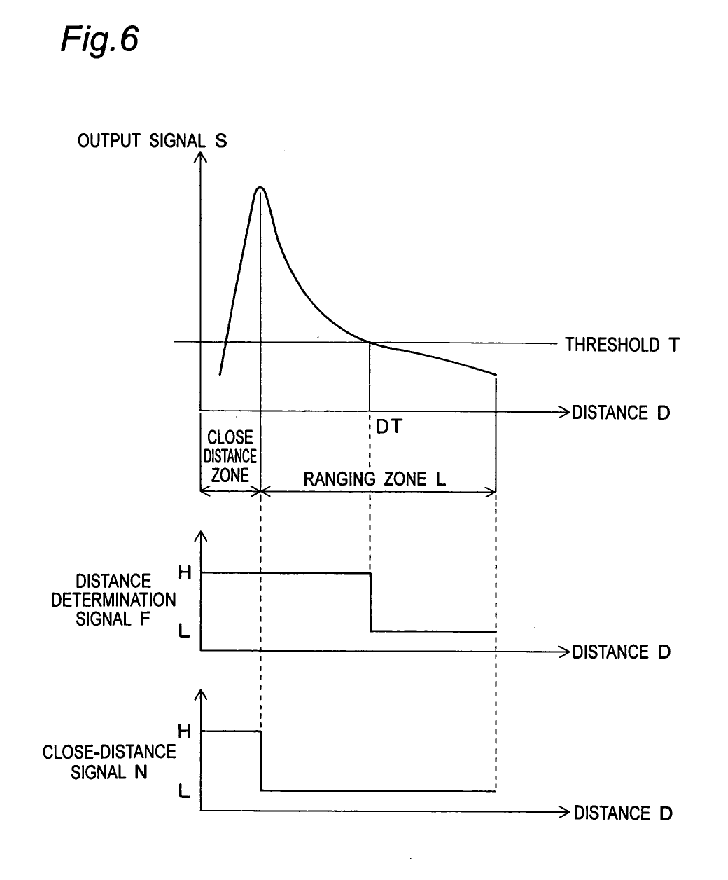

FIG. 6 is a diagram showing the signals outputted from the signal processing circuit 7 of the optical ranging sensor of the embodiment. The signal processing circuit 7 of the embodiment carries out comparison between output signal S based on signal currents I1, I2 from the light receiving device 5 and a threshold T as reference signal inputted from external. When the output signal S is smaller than the threshold T, it is determined that the distance is larger than a reference distance DT corresponding to the threshold T and a distance determination signal F of L (Low) is outputted, as shown in FIG. 6. When the output signal S is larger than the threshold T, it is determined that the distance to the object is smaller than the reference distance DT and a distance determination signal F of H (High) is outputted. Thus information on the distance D to the object can be outputted with use of two values (the H/L outputs).

A close-distance signal N of L (Low) may be outputted upon determination that the object is not in the close distance zone, and a close-distance signal N of H (High) may be outputted upon determination that the object is in the close distance zone. Thus whether the object is in the close-distance zone can be made clear in addition to whether the distance to the object to be ranged is smaller than the reference distance DT.

In the embodiment, as is the case with the second embodiment, the first light receiving device 51 and the second light receiving device 52 may be provided, the output signal S may be obtained based on the signal currents I1, I2 from the first light receiving device 51, and the presence in the close distance zone may be determined based on the signal current I3 from the second light receiving device 52.

### Fourth Embodiment

An optical ranging sensor of a fourth embodiment has substantially the same configuration as the optical ranging sensor 1 of the first embodiment except signals outputted from the signal processing circuit 7. For the present embodiment, detailed description of the same parts thereof as those of the first embodiment is omitted with using the same reference numerals as the first embodiment.

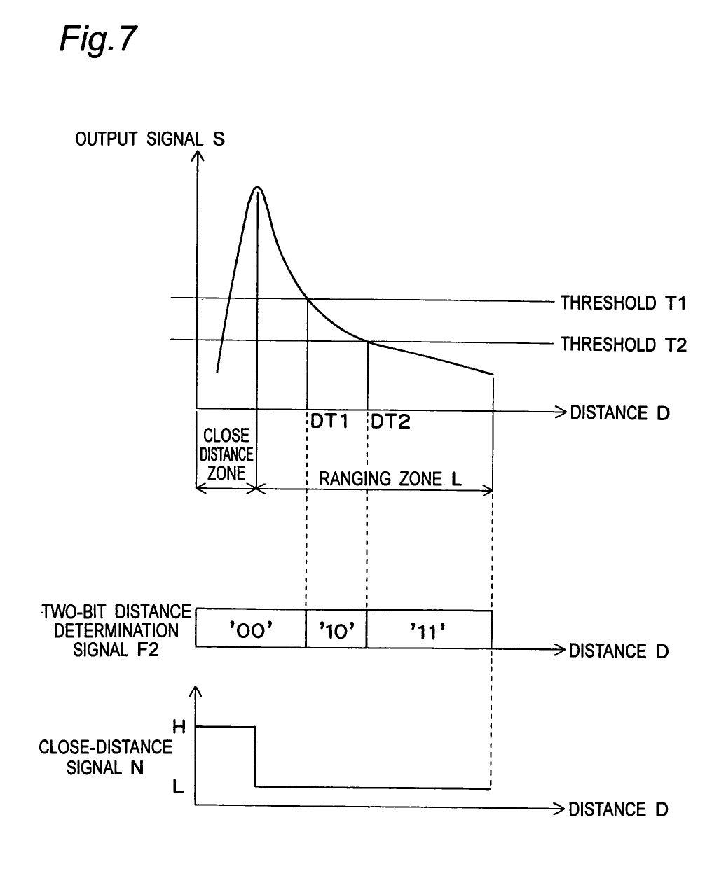

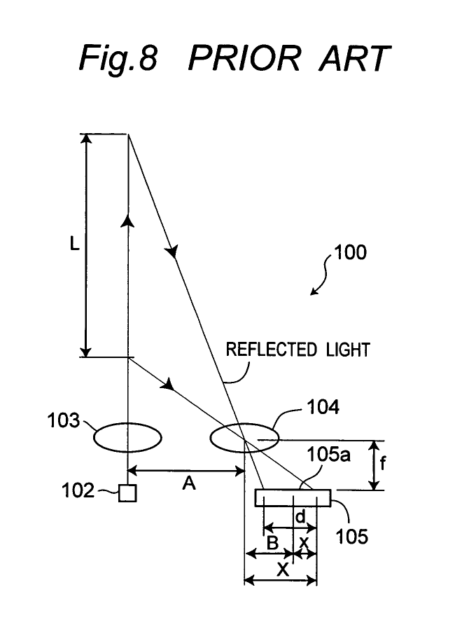

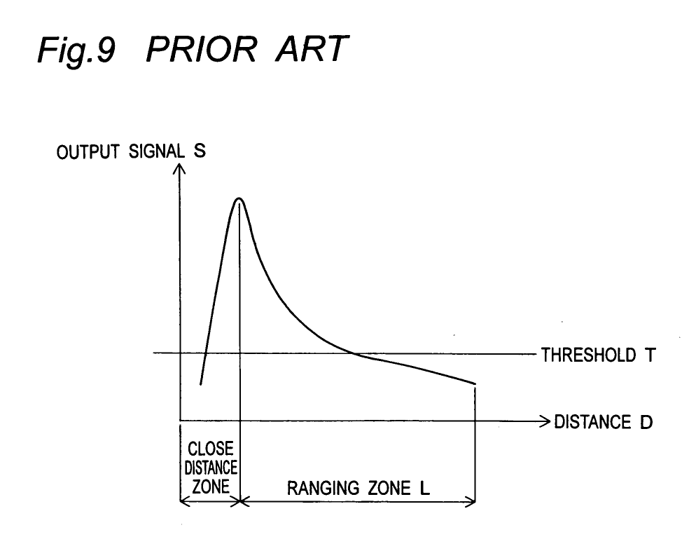

FIG. 7 is a diagram showing signals outputted from the signal processing circuit 7 of the optical ranging sensor of the embodiment. In the embodiment, as shown in FIG. 7, comparison is carried out between output signal S based on signal currents I1, I2 from the light receiving device 5 and thresholds T1, T2 as a plurality of reference signals inputted from external. When the output signal S is smaller than the threshold T2, it is determined that the distance to the object is larger than a reference distance DT2 corresponding to the threshold T2 and a two-bit distance determination signal F2 having a value “11” is outputted, as shown in FIG. 7. When the output signal S is larger than the threshold T2 and smaller than the threshold T1, it is determined that the distance to the object is smaller than the reference distance DT2 and larger than a reference distance DT1 corresponding to the threshold T1 and a two-bit distance determination signal F2 having a value “10” is outputted. When the output signal S is larger than the threshold T1, it is determined that the distance to the object is smaller than the reference distance DT1 and a two-bit distance determination signal F2 having a value “00” is outputted. With use of the two-bit values, in this manner, there can be outputted which zone the object to be ranged exists in out of the distance zones defined by the reference distances DT1 and DT2.

A close-distance signal N of H (High) may be outputted upon determination that the object is in the close-distance zone, and a close-distance signal N of L (Low) may be outputted upon determination that the object is not in the close-distance zone. Thus whether the object is in the close-distance zone can be outputted in addition to which zone the object to be ranged exists in out of the distance zones defined by the reference distances DT1 and DT2.

In the embodiment, as is the case with the second embodiment, the first light receiving device 51 and the second light receiving device 52 may be provided, the output signal S may be obtained based on the signal currents I1, I2 from the first light receiving device 51, and the presence in the close distance zone may be determined based on the signal current I3 from the second light receiving device 52.

The optical ranging sensors according to the above embodiments can be used in various types of electrical equipment. Among such electrical equipment are automatic faucet device, automatic drier device, automatic washing toilet seat device, automatic switching valve seat device, automatic vacuum cleaner, and the like. With use of the optical ranging sensors of the above embodiments, whether the object is in the close distance zone can accurately be detected, so that malfunction of the electrical equipment can be prevented.

In the embodiments, each of the light receiving devices 5, 51, and 52 is formed of a pin photodiode. The light receiving devices, however, are not limited thereto and may be formed of other elements such as pn diode. In short, the invention can widely be applied to light receiving devices having output characteristics in which the output rapidly changes when the object nears the light receiving device beyond the ranging zone. Besides, the shape of the light receiving surface is not limited to the shape of the slender rectangle.

Embodiments of the invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. An optical ranging sensor of trigonometrical ranging type, comprising:
a light emitting device for emitting light;
a light projecting condenser unit for condensing the light emitted from the light emitting device and projecting the light onto an object to be ranged;
a light receiving condenser unit for condensing the light projected onto and reflected by the object to be ranged;
a first light receiving device for receiving the light condensed by the light receiving condenser unit and outputting distance signal corresponding to a distance to the object to be ranged; and
a close-distance detection circuit for detecting whether the object to be ranged is in a predetermined close distance zone.

2. An optical ranging sensor as claimed in claim 1, further comprising a close-distance signal output unit for outputting a close-distance signal indicating presence or absence of the object to be ranged in the close-distance zone, based on a result of detection by the close-distance detection circuit.

3. An optical ranging sensor as claimed in claim 2, further comprising an output control unit that outputs to external the distance signal from the first light receiving device when the close-distance detection circuit detects absence of the object to be ranged in the close distance zone and that outputs to external the close-distance signal from the close-distance signal output unit when the close-distance detection circuit detects presence of the object to be ranged in the close distance zone.

4. An optical ranging sensor as claimed in claim 1, further comprising a second light receiving device,
wherein the second light receiving device receives light emitted from the light emitting device and reflected by the object to be ranged existing in the close distance zone.

5. An optical ranging sensor as claimed in claim 4, wherein the first light receiving device and the second light receiving device are formed on one board.

6. An optical ranging sensor as claimed in claim 1, wherein the first light receiving device and the close-distance detection circuit are formed on one board.

7. An optical ranging sensor as claimed in claim 1, further comprising a determination output circuit that determines and outputs whether the distance to the object to be ranged is larger than a predetermined reference distance, based on the distance signal outputted from the first light receiving device and a reference signal inputted from external and indicating the predetermined reference distance.

8. An optical ranging sensor as claimed in claim 2, further comprising a determination output circuit that determines and outputs whether the distance to the object to be ranged is larger than a predetermined reference distance, based on the distance signal outputted from the first light receiving device and a reference signal inputted from external and indicating the predetermined reference distance.

9. An optical ranging sensor as claimed in claim 1, further comprising a distance zone detection output circuit that identifies and outputs which zone the object to be ranged exists in out of a plurality of distance zones defined by predetermined reference distances, based on the distance signal outputted from the first light receiving device and a plurality of reference signals inputted from external and indicating the predetermined reference distances.

10. An optical ranging sensor as claimed in claim 2, further comprising a distance zone detection output circuit that identifies and outputs which zone the object to be ranged exists in out of a plurality of distance zones defined by predetermined reference distances, based on the distance signal outputted from the first light receiving device and a plurality of reference signals inputted from external and indicating the predetermined reference distances.

11. Electrical equipment comprising an optical ranging sensor as claimed in any one of claims 1 through 10.
